(19) United States
(12) Patent Application Publication
(10) Pub. No.: US 2025/0341621 A1
(43) Pub. Date: Nov. 6, 2025

(54) ROBUST LIDAR TO CAMERA ALIGNMENT METHOD FOR A VEHICLE

(71) Applicant: GM Global Technology Operations LLC, Detroit, MI (US)

(72) Inventors: Yousef Adnan Omar, Troy, MI (US); Mark Wolski, Warren, MI (US); Hao Yu, Troy, MI (US); Wende Zhang, Birmingham, MI (US)

(21) Appl. No.: 18/655,543

(22) Filed: May 6, 2024

(51) Int. Cl. G01S 7/497; G01S 17/89

(52) U.S. Cl. CPC G01S 7/4972; G01S 17/89

(57) ABSTRACT

A method for determining light detection and ranging (LiDAR) to camera calibration parameters for a vehicle includes collecting pre-alignment LiDAR data and pre-alignment camera data. The method further may include determining pre-alignment LiDAR to camera calibration parameters based on the pre-alignment LiDAR data and the pre-alignment camera data. The method further may include collecting deep-alignment LiDAR data and deep-alignment camera data based at least in part on the pre-alignment LiDAR to camera calibration parameters. The method further may include determining final LIDAR to camera calibration parameters based at least in part on the deep-alignment LiDAR data and the deep-alignment camera data.

### INTRODUCTION

The present disclosure relates to sensing systems and methods for vehicles, and more particularly, to systems and methods for calibrating sensors for a vehicle.

To increase occupant awareness and convenience, vehicles may be equipped with various sensors such as cameras, radar, and LiDAR (light detection and ranging). Sensors may be used to detect and identify objects around the vehicle, including other vehicles, pedestrians, road configurations, traffic signs, road markings, and more. Sensors may also be used to enable advanced driver assistance systems (ADAS) and/or automated driving systems (ADS). ADAS systems may take actions based on environmental conditions surrounding the vehicle, such as applying brakes or alerting an occupant of the vehicle. ADS systems may use the sensors to detect objects in the environment around the vehicle and control the vehicle to navigate the vehicle through the environment to a predetermined destination. However, vehicle sensor systems may not account for the need for recalibration after service or maintenance is performed on the vehicle, and thus may be prone to errors, misalignments, and/or false readings caused by sensor miscalibration.

Thus, while vehicle sensor systems and methods achieve their intended purpose, there is a need for a new and improved system and method for calibrating sensors for a vehicle.

### SUMMARY

According to several aspects, a method for determining light detection and ranging (LiDAR) to camera calibration parameters for a vehicle is provided. The method may include collecting pre-alignment LiDAR data including a first plurality of LiDAR data points and pre-alignment camera data including a first plurality of camera data points. The method further may include determining pre-alignment LiDAR to camera calibration parameters based on the pre-alignment LiDAR data and the pre-alignment camera data. The method further may include collecting deep-alignment LiDAR data including a second plurality of LiDAR data points and deep-alignment camera data including a second plurality of camera data points based at least in part on the pre-alignment LiDAR to camera calibration parameters. The second plurality of LiDAR data points includes a greater quantity of LiDAR data points than the first plurality of LiDAR data points. The second plurality of camera data points includes a greater quantity of camera data points than the first plurality of camera data points. The method further may include determining final LiDAR to camera calibration parameters based at least in part on the deep-alignment LIDAR data and the deep-alignment camera data.

In another aspect of the present disclosure, collecting the pre-alignment LiDAR data and the pre-alignment camera data further may include maneuvering the vehicle through a parking lot using a predetermined driving path. Collecting the pre-alignment LiDAR data and the pre-alignment camera data further may include collecting the first plurality of LiDAR data points using a LiDAR sensor while the vehicle is following the predetermined driving path. Collecting the pre-alignment LiDAR data and the pre-alignment camera data further may include collecting the first plurality of camera data points using a camera while the vehicle is following the predetermined driving path.

In another aspect of the present disclosure, maneuvering the vehicle through the parking lot using the predetermined driving path further may include driving the vehicle through an aisle of the parking lot at less than or equal to a predetermined maximum speed. The parking lot is populated with a plurality of parked vehicles. Maneuvering the vehicle through the parking lot using the predetermined driving path further may include maneuvering the vehicle using the predetermined driving path. The predetermined driving path is an S-shaped driving path.

In another aspect of the present disclosure, collecting the pre-alignment LiDAR data further may include measuring the first plurality of LiDAR data points. Each of the first plurality of LiDAR data points corresponds to a location of one of a plurality of edges of one of a plurality of objects in an environment surrounding the vehicle. One or more of the first plurality of LiDAR data points has a location outside of a field-of-view of the camera.

In another aspect of the present disclosure, collecting the pre-alignment camera data further may include capturing a first plurality of images using the camera. The first plurality of images includes a first quantity of images. Collecting the pre-alignment camera data further may include generating a first plurality of bounding boxes on each of the first plurality of images. Each of the first plurality of bounding boxes identifies one of the plurality of objects in the first plurality of images. Collecting the pre-alignment camera data further may include generating detecting the plurality of edges of each of the plurality of objects in the plurality of images. Collecting the pre-alignment camera data further may include generating determining the first plurality of camera data points. Each of the first plurality of camera data points corresponds to one of the plurality of edges which does not overlap with any of the first plurality of bounding boxes.

In another aspect of the present disclosure, determining pre-alignment LiDAR to camera calibration parameters further may include determining a pre-alignment spatial transformation necessary to align the first plurality of LiDAR data points with the first plurality of camera data points. Determining pre-alignment LiDAR to camera calibration parameters further may include determining the pre-alignment LiDAR to camera calibration parameters based at least in part on the pre-alignment spatial transformation.

In another aspect of the present disclosure, collecting the deep-alignment LiDAR data and the deep-alignment camera data further may include driving the vehicle through an aisle of a parking lot at less than or equal to a predetermined maximum speed. The parking lot is populated with a plurality of parked vehicles. Collecting the deep-alignment LiDAR data and the deep-alignment camera data further may include maneuvering the vehicle using a predetermined driving path. The predetermined driving path is an S-shaped driving path. Collecting the deep-alignment LiDAR data and the deep-alignment camera data further may include collecting the second plurality of LIDAR data points using a LIDAR sensor while the vehicle is following the S-shaped driving path. Collecting the deep-alignment LiDAR data and the deep-alignment camera data further may include performing a spatial transformation on the second plurality of LiDAR data points based at least in part on the pre-alignment LiDAR to camera calibration parameters. Collecting the deep-alignment LiDAR data and the deep-alignment camera data further may include collecting the second plurality of camera data points using a camera while the vehicle is following the S-shaped driving path.

In another aspect of the present disclosure, collecting the deep-alignment LiDAR data further may include measuring the second plurality of LiDAR data points. Each of the second plurality of LiDAR data points corresponds to a location of one of a plurality of edges of one of a plurality of objects in an environment surrounding the vehicle. One or more of the second plurality of LiDAR data points has a location outside of a field-of-view of the camera.

In another aspect of the present disclosure, collecting the deep-alignment camera data further may include capturing a second plurality of images using the camera. The second plurality of images includes a second quantity of images. Collecting the deep-alignment camera data further may include generating a second plurality of bounding boxes on each of the second plurality of images. Each of the second plurality of bounding boxes identifies one of the plurality of objects in the second plurality of images. Collecting the deep-alignment camera data further may include detecting the plurality of edges of each of the plurality of objects in the second plurality of images. Collecting the deep-alignment camera data further may include determining the second plurality of camera data points. Each of the second plurality of camera data points corresponds to one of the plurality of edges which does not overlap with any of the second plurality of bounding boxes.

In another aspect of the present disclosure, determining the final LiDAR to camera calibration parameters further may include determining a final spatial transformation necessary to align the second plurality of LiDAR data points with the second plurality of camera data points. Determining the final LiDAR to camera calibration parameters further may include determining the final LiDAR to camera calibration parameters based at least in part on the final spatial transformation.

According to several aspects, a system for determining light detection and ranging (LiDAR) to camera calibration parameters for a vehicle is provided, the system may include a LIDAR sensor, a camera, and a controller in electrical communication with the LiDAR sensor and the camera. The controller is programmed to determine a pre-alignment LiDAR to camera calibration parameter using a pre-alignment procedure. The pre-alignment procedure is performed using a sparse dataset. The controller is further programmed to apply the pre-alignment LiDAR to camera calibration parameter to decrease an initial LiDAR to camera alignment error. The controller is further programmed to determine a final LiDAR to camera calibration parameter using a deep-alignment procedure. The deep-alignment procedure is performed using a dense dataset.

In another aspect of the present disclosure, to determine the pre-alignment LiDAR to camera calibration parameter, the controller is further programmed to collect a first plurality of LiDAR data points using the LiDAR sensor while the vehicle is following an S-shaped driving path through an aisle of a parking lot populated with a plurality of parked vehicles. To determine the pre-alignment LiDAR to camera calibration parameter, the controller is further programmed to collect a first plurality of camera data points using the camera while the vehicle is following the S-shaped driving path through the aisle of the parking lot populated with the plurality of parked vehicles.

In another aspect of the present disclosure, to collect the first plurality of LiDAR data points and the first plurality of camera data points, the controller is further programmed to measure the first plurality of LiDAR data points. Each of the first plurality of LiDAR data points corresponds to a location of one of a plurality of edges of one of the plurality of parked vehicles in the parking lot. One or more of the first plurality of LiDAR data points has a location outside of a field-of-view of the camera. To collect the first plurality of LiDAR data points and the first plurality of camera data points, the controller is further programmed to capture a first plurality of images using the camera. To collect the first plurality of LiDAR data points and the first plurality of camera data points, the controller is further programmed to generate a first plurality of bounding boxes on each of the first plurality of images. Each of the first plurality of bounding boxes identifies one of the plurality of parked vehicles in the first plurality of images. To collect the first plurality of LiDAR data points and the first plurality of camera data points, the controller is further programmed to detect the plurality of edges of each of the plurality of parked vehicles in the first plurality of images. To collect the first plurality of LiDAR data points and the first plurality of camera data points, the controller is further programmed to determine the first plurality of camera data points. Each of the first plurality of camera data points corresponds to one of the plurality of edges which does not overlap with any of the first plurality of bounding boxes.

In another aspect of the present disclosure, to determine the pre-alignment LiDAR to camera calibration parameter, the controller is further programmed to determine a pre-alignment spatial transformation necessary to align the first plurality of LiDAR data points with the first plurality of camera data points. To determine the pre-alignment LiDAR to camera calibration parameter, the controller is further programmed to determine the pre-alignment LiDAR to camera calibration parameter based at least in part on the pre-alignment spatial transformation.

In another aspect of the present disclosure, to determine the final LiDAR to camera calibration parameter, the controller is further programmed to collect a second plurality of LiDAR data points using the LiDAR sensor while the vehicle is following the S-shaped driving path through the aisle of the parking lot populated with the plurality of parked vehicles. The second plurality of LiDAR data points includes a greater quantity of LiDAR data points than the first plurality of LiDAR data points. To determine the final LiDAR to camera calibration parameter, the controller is further programmed to collect a second plurality of camera data points using the camera while the vehicle is following the S-shaped driving path through the aisle of the parking lot populated with the plurality of parked vehicles. The second plurality of camera data points includes a greater quantity of camera data points than the first plurality of camera data points.

In another aspect of the present disclosure, to collect the second plurality of LiDAR data points and the second plurality of camera data points, the controller is further programmed to measure the second plurality of LIDAR data points. Each of the second plurality of LiDAR data points corresponds to a location of one of a plurality of edges of one of the plurality of parked vehicles in the parking lot. One or more of the second plurality of LiDAR data points has a location outside of a field-of-view of the camera. To collect the second plurality of LiDAR data points and the second plurality of camera data points, the controller is further programmed to capture a second plurality of images using the camera. To collect the second plurality of LiDAR data points and the second plurality of camera data points, the controller is further programmed to generate a second plurality of bounding boxes on each of the second plurality of images. Each of the second plurality of bounding boxes identifies one of the plurality of parked vehicles in the second plurality of images. To collect the second plurality of LiDAR data points and the second plurality of camera data points, the controller is further programmed to detect the plurality of edges of each of the plurality of parked vehicles in the second plurality of images. To collect the second plurality of LiDAR data points and the second plurality of camera data points, the controller is further programmed to determine the second plurality of camera data points. Each of the second plurality of camera data points corresponds to one of the plurality of edges which does not overlap with any of the second plurality of bounding boxes.

In another aspect of the present disclosure, to determine the final LiDAR to camera calibration parameter, the controller is further programmed to determine a final spatial transformation necessary to align the second plurality of LiDAR data points with the second plurality of camera data points. To determine the final LiDAR to camera calibration parameter, the controller is further programmed to determine the final LiDAR to camera calibration parameter based at least in part on the final spatial transformation.

According to several aspects, a method for determining light detection and ranging (LiDAR) to camera calibration parameters for a vehicle is provided. The method may include maneuvering the vehicle through a parking lot using a predetermined driving path. The method further may include collecting a first plurality of LiDAR data points using a LIDAR sensor while the vehicle is following the predetermined driving path. The method further may include collecting a first plurality of camera data points using a camera while the vehicle is following the predetermined driving path. The method further may include determining pre-alignment LiDAR to camera calibration parameters based on the first plurality of LiDAR data points and the first plurality of camera data points. The method further may include collecting a second plurality of LIDAR data points using the LiDAR sensor while the vehicle is following the predetermined driving path. The second plurality of LiDAR data points includes a greater quantity of LiDAR data points than the first plurality of LiDAR data points. The method further may include collecting a second plurality of camera data points using the camera while the vehicle is following the predetermined driving path. The second plurality of camera data points includes a greater quantity of camera data points than the first plurality of camera data points. The method further may include performing a spatial transformation on the second plurality of LiDAR data points based at least in part on the pre-alignment LiDAR to camera calibration parameters. The method further may include determining final LiDAR to camera calibration parameters based at least in part on the second plurality of LiDAR data points and the second plurality of camera data points.

In another aspect of the present disclosure, collecting the first plurality of LiDAR data points, the second plurality of LiDAR data points, the first plurality of camera data points, and the second plurality of camera data points further may include measuring the first and second plurality of LiDAR data points. Each of the first and second plurality of LiDAR data points corresponds to a location of one of a plurality of edges of one of a plurality of objects in an environment surrounding the vehicle. One or more of the first and second plurality of LiDAR data points has a location outside of a field-of-view of the camera. Collecting the first plurality of LiDAR data points, the second plurality of LiDAR data points, the first plurality of camera data points, and the second plurality of camera data points further may include capturing a first plurality of images and a second plurality of images using the camera. The second plurality of images includes a greater quantity of images than the first plurality of images. Collecting the first plurality of LiDAR data points, the second plurality of LiDAR data points, the first plurality of camera data points, and the second plurality of camera data points further may include generating a first plurality of bounding boxes on each of the first plurality of images and a second plurality of bonding boxes on each of the second plurality of images. Each of the first and second plurality of bounding boxes identifies one of the plurality of objects in the first plurality of images and the second plurality of images. Collecting the first plurality of LiDAR data points, the second plurality of LiDAR data points, the first plurality of camera data points, and the second plurality of camera data points further may include detecting a first plurality of edges of each of the plurality of objects in the first plurality of images and a second plurality of edges of each of the plurality of objects in the second plurality of images. Collecting the first plurality of LiDAR data points, the second plurality of LiDAR data points, the first plurality of camera data points, and the second plurality of camera data points further may include determining the first plurality of camera data points. Each of the first plurality of camera data points corresponds to one of the first plurality of edges which does not overlap with any of the first plurality of bounding boxes. Collecting the first plurality of LiDAR data points, the second plurality of LiDAR data points, the first plurality of camera data points, and the second plurality of camera data points further may include determining the second plurality of camera data points. Each of the second plurality of camera data points corresponds to one of the second plurality of edges which does not overlap with any of the second plurality of bounding boxes.

In another aspect of the present disclosure, determining the final LiDAR to camera calibration parameters further may include determining a final spatial transformation necessary to align the second plurality of LiDAR data points with the second plurality of camera data points. Determining the final LiDAR to camera calibration parameters further may include determining the final LiDAR to camera calibration parameters based at least in part on the final spatial transformation.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a system for determining light detection and ranging (LiDAR) to camera calibration parameters for a vehicle, according to an exemplary embodiment;

FIG. 2 is a schematic diagram of parking lot, according to an exemplary embodiment;

FIG. 3 is a schematic diagram of a parked vehicle overlayed with camera data and LiDAR data, according to an exemplary embodiment;

FIG. 4 is a flowchart of the method for determining LiDAR to camera calibration parameters for a vehicle, according to an exemplary embodiment; and

FIG. 5 is a flowchart of a method for collecting LiDAR data and camera data, according to an exemplary embodiment.

### DETAILED DESCRIPTION

The following description is merely exemplary in nature and is not intended to limit the present disclosure, application, or uses.

In aspects of the present disclosure, service performed on vehicle components such as vehicle sensor systems may result in misalignment and/or calibration errors. Current techniques for calibrating vehicle sensor systems may require specialized equipment and may result in decreased system accuracy and/or performance. Accordingly, the present disclosure provides a new and improved system and method for determining light detection and ranging (LiDAR) to camera calibration parameters for a vehicle which allows for recalibration of vehicle sensor systems after service without specialized equipment and in a time-efficient manner.

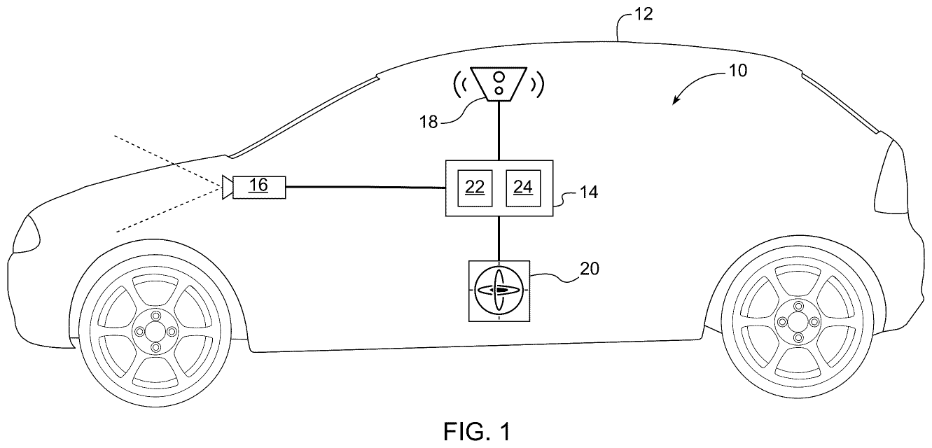

Referring to FIG. 1, a system for determining light detection and ranging (LiDAR) to camera calibration parameters for a vehicle is illustrated and generally indicated by reference number 10. The system 10 is shown with an exemplary vehicle 12. While a passenger vehicle is illustrated, it should be appreciated that the vehicle 12 may be any type of vehicle without departing from the scope of the present disclosure. The system 10 generally includes a controller 14, a camera 16, a LIDAR sensor 18, and an inertial measurement unit (IMU) 20.

The controller 14 is used to implement a method 100 for determining LiDAR to camera calibration parameters, as will be described below. The controller 14 includes at least one processor 22 and a non-transitory computer readable storage device or media 24. The processor 22 may be a custom made or commercially available processor, a central processing unit (CPU), a graphics processing unit (GPU), an auxiliary processor among several processors associated with the controller 14, a semiconductor-based microprocessor (in the form of a microchip or chip set), a macroprocessor, a combination thereof, or generally a device for executing instructions.

The computer readable storage device or media 24 may include volatile and nonvolatile storage in read-only memory (ROM), random-access memory (RAM), and keep-alive memory (KAM), for example. KAM is a persistent or non-volatile memory that may be used to store various operating variables while the processor 22 is powered down. The computer-readable storage device or media 24 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 14 to control various systems of the vehicle 12.

The controller 14 may also consist of multiple controllers which are in electrical communication with each other. The controller 14 may be inter-connected with additional systems and/or controllers of the vehicle 12, allowing the controller 14 to access data such as, for example, speed, acceleration, braking, and steering angle of the vehicle 12.

The controller 14 is in electrical communication with the camera 16, the LiDAR sensor 18, and the IMU 20. In an exemplary embodiment, the electrical communication is established using, for example, a CAN network, a FLEXRAY network, a local area network (e.g., WiFi, ethernet, and the like), a serial peripheral interface (SPI) network, or the like. It should be understood that various additional wired and wireless techniques and communication protocols for communicating with the controller 14 are within the scope of the present disclosure. It should further be understood that, in the scope of the present disclosure, electrical communication also includes power and/or energy transfer between electrical devices (e.g., using conducting wires and/or wireless power transmission techniques).

The camera 16 is a perception sensor used to capture images and/or videos of the environment surrounding the vehicle 12. In an exemplary embodiment, the camera 16 includes a photo and/or video camera which is positioned to view the environment surrounding the vehicle 12. In a non-limiting example, the camera 16 includes a camera affixed inside of the vehicle 12, for example, in a headliner of the vehicle 12, having a view through the windscreen. In another non-limiting example, the camera 16 includes a camera affixed outside of the vehicle 12, for example, on a roof of the vehicle 12, having a view of the environment in front of the vehicle 12.

In another exemplary embodiment, the camera 16 is a surround view camera system including a plurality of cameras (also known as satellite cameras) arranged to provide a view of the environment adjacent to all sides of the vehicle 12. In a non-limiting example, the camera 16 includes a front-facing camera (mounted, for example, in a front grille of the vehicle 12), a rear-facing camera (mounted, for example, on a rear tailgate of the vehicle 12), and two side-facing cameras (mounted, for example, under each of two side-view mirrors of the vehicle 12). In another non-limiting example, the camera 16 further includes an additional rear-view camera mounted near a center high mounted stop lamp of the vehicle 12.

It should be understood that camera systems having additional cameras and/or additional mounting locations are within the scope of the present disclosure. It should further be understood that cameras having various sensor types including, for example, charge-coupled device (CCD) sensors, complementary metal oxide semiconductor (CMOS) sensors, and/or high dynamic range (HDR) sensors are within the scope of the present disclosure. Furthermore, cameras having various lens types including, for example, wide-angle lenses and/or narrow-angle lenses are also within the scope of the present disclosure. The camera 16 is in electrical communication with the controller 14, as discussed above.

The LiDAR sensor 18 is utilized for remote sensing and environmental mapping by emitting laser pulses and measuring the time it takes for the laser pulses to return to the LiDAR sensor 18 after hitting objects. In an exemplary embodiment, the LiDAR sensor 18 includes a LiDAR laser source, a LIDAR scanner or mirror, a LiDAR photodetector, and a LiDAR time-of-flight measurement system. In a non-limiting example, the LiDAR laser source emits laser pulses that travel to the target area, and the LiDAR scanner directs these pulses in different directions. The emitted laser pulses interact with objects in the environment and their reflections are captured by the LiDAR photodetector. The LiDAR time-of-flight measurement system calculates the distance to the objects based on the time between emission of the laser pulses by the LiDAR laser source and reception of the reflected laser pulses by the LiDAR photodetector. The LiDAR sensor 18 is in electrical communication with the controller 14, as discussed above.

The IMU 20 is used to determine an orientation, velocity, and gravitational forces acting upon the vehicle 12. In an exemplary embodiment, the IMU 20 includes several sensors, including accelerometers, gyroscopes, and/or magnetometers. In a non-limiting example, the IMU 20 includes three-axis accelerometers and three-axis gyroscopes, which are integrated into a single unit. The accelerometers measure linear acceleration along each axis, while the gyroscopes measure angular velocity about each axis. The IMU 20 processes data from the sensors to calculate the current orientation, speed, heading, yaw rate (i.e., rate of change of heading), and acceleration of the vehicle 12 in three-dimensional space. The IMU 20 is in electrical communication with the controller 14, as discussed above.

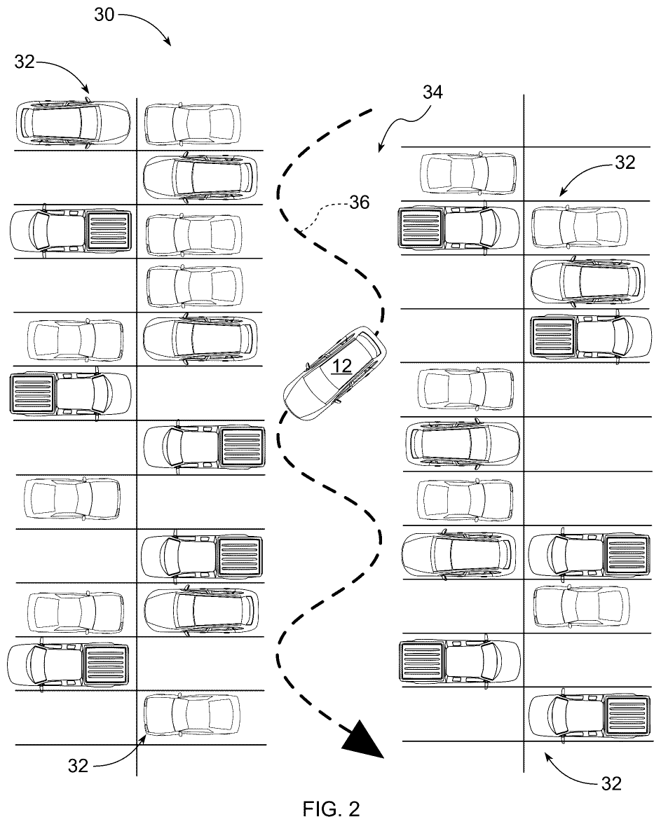

Referring to FIG. 2, a schematic diagram of parking lot 30 is shown. The parking lot 30 includes a plurality of parked vehicles 32 and a parking lot aisle 34. It should be understood that the parking lot 30, the plurality of parked vehicles 32, and the parking lot aisle 34 depicted in FIG. 2 are merely exemplary in nature. Variations in size, shape, capacity, location, configuration and/or the like of the parking lot 30, the plurality of parked vehicles 32, and the parking lot aisle 34 are within the scope of the present disclosure. During performance of the method 100, the vehicle 12 is maneuvered through the parking lot aisle 34 of the parking lot 30 using a predetermined driving path 36, as will be discussed in greater detail below. In an exemplary embodiment, the predetermined driving path 36 is an S-shaped driving path having an approximately sinusoidal shape as shown in FIG. 2.

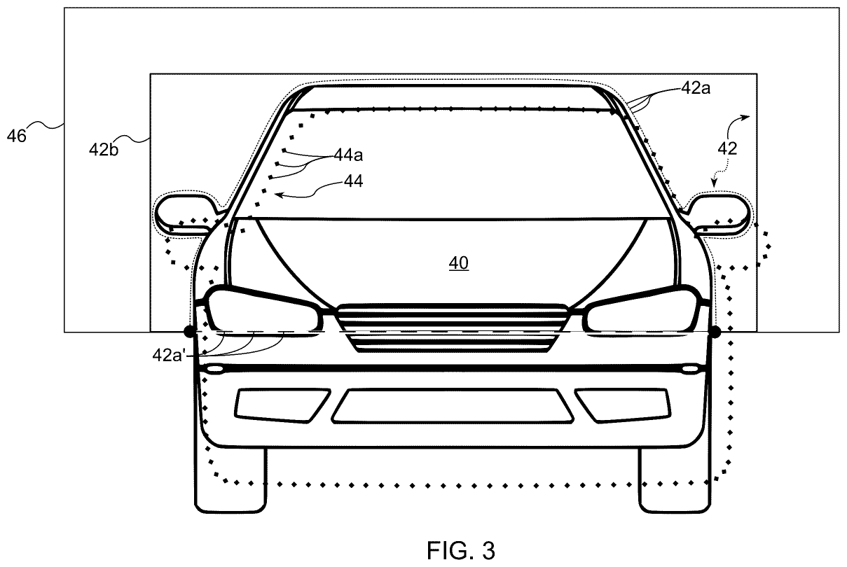

Referring to FIG. 3, a schematic diagram of a parked vehicle 40 of the plurality of parked vehicles 32 as seen from the perspective of the vehicle 12 while maneuvering in the parking lot aisle 34 of the parking lot 30 is shown overlayed with camera data 42 and LiDAR data 44. It should be understood that while the parked vehicle 40 is shown in a head-on orientation, the parked vehicle 40 may be in any orientation (e.g., a rear-facing, a side-facing, and/or an oblique orientation) without departing from the scope of the present disclosure. The camera data 42 includes a plurality of camera data points 42a and a bounding box 42b within a camera field-of-view 46 of the camera 16. The bounding box 42b indicates the parked vehicle 40 and the plurality of camera data points 42a indicate edges of the parked vehicle 40.

The LiDAR data 44 includes a plurality of LiDAR data points 44a. Ideally, the plurality of LiDAR data points 44a indicate the edges of the parked vehicle 40 and the plurality of LiDAR data points 44a should be coincident with the plurality of camera data points 42a. However, as shown in FIG. 3, in some examples, misalignment may occur between data collected by the camera 16 and data collected by the LiDAR sensor 18. Therefore, LiDAR to camera calibration parameters are used to align the data collected by the LIDAR sensor 18 with the data collected by the camera 16, as will be discussed in greater detail below.

As shown in FIG. 3, the camera data 42 is only available within the camera field-of-view 46. Therefore, in some examples, phantom camera data points 42a′ are created where any of the plurality of camera data points 42a are coincident with the bounding box 42b. These points are referred to as phantom camera data points 42a′ because they do not correspond to an actual edge of the parked vehicle 40, but rather an artificial (i.e., phantom) edge which occurs because parts of the parked vehicle 40 are located outside of the camera field-of-view 46. In contrast to the camera data 42, the LiDAR data 44 may be available outside of the camera field-of-view 46. Therefore, as shown in FIG. 3, one or more of the plurality of LiDAR data points 44a has a location outside of the camera field-of-view 46.

It should be understood that while FIG. 3 shows a single parked vehicle 40, the camera data 42 and LiDAR data 44 may include camera data points, bounding boxes, and LiDAR data points from multiple parked vehicles. For example, as the vehicle 12 maneuvers in the parking lot aisle 34 of the parking lot 30, the camera data 42 and LiDAR data 44 are accumulated for some or all of the plurality of parked vehicles 32. Throughout the following disclosure, a first plurality of camera data points, a second plurality of camera data points, a plurality of bounding boxes, a first plurality of LiDAR data points, and a second plurality of LiDAR data points will be discussed.

In the scope of the present disclosure, the first plurality of camera data points is a subset of the plurality of camera data points 42a which includes less than all of the plurality of camera data points 42a (e.g., less than fifty percent of the data points of the plurality of camera data points 42a). In other words, the first plurality of camera data points is a sparse dataset relative to the entire plurality of camera data points 42a. In the scope of the present disclosure, the second plurality of camera data points is a subset of the plurality of camera data points 42a which includes most or all of the plurality of camera data points 42a (i.e., a greater quantity of camera data points than the first plurality of camera data points). In other words, the second plurality of camera data points is a dense dataset relative to the first plurality of camera data points. In the scope of the present disclosure, the plurality of bounding boxes refers to the bounding box 42b corresponding to each of the plurality of parked vehicles 32 detected in the parking lot 30.

In the scope of the present disclosure, the first plurality of LIDAR data points is a subset of the plurality of LiDAR data points 44a which includes less than all of the plurality of LiDAR data points 44a (e.g., less than fifty percent of the data points of the plurality of LiDAR data points 44a). In other words, the first plurality of LiDAR data points is a sparse dataset relative to the entire plurality of LiDAR data points 44a. In the scope of the present disclosure, the second plurality of LiDAR data points is a subset of the plurality of LiDAR data points 44a which includes most or all of the plurality of LiDAR data points 44a (i.e., a greater quantity of LiDAR data points than the first plurality of LiDAR data points). In other words, the second plurality of LiDAR data points is a dense dataset relative to the first plurality of LiDAR data points. The acquisition and use of the camera data 42 and the LiDAR data 44 will be discussed in greater detail below.

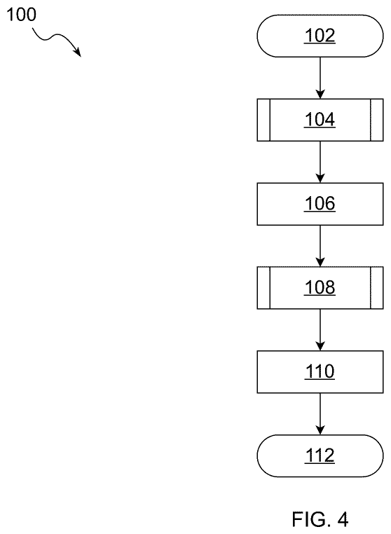

In FIG. 4, a flowchart of the method 100 for determining LiDAR to camera calibration parameters for a vehicle is provided. Referring to FIG. 4 and with continued reference to FIGS. 1-3, the method 100 begins at block 102 and proceeds to block 104. At block 104, the controller 14 collects pre-alignment LiDAR data and pre-alignment camera data. In the scope of the present disclosure, the pre-alignment LiDAR data includes the first plurality of LIDAR data points. In the scope of the present disclosure, the pre-alignment camera data includes the first plurality of camera data points and the plurality of bounding boxes. Collection of the pre-alignment LiDAR data and pre-alignment camera data will be discussed in greater detail below. After block 104, the method 100 proceeds to block 106.

At block 106, the controller 14 determines pre-alignment LIDAR to camera calibration parameters. In a non-limiting example, the LiDAR data 44 may become misaligned with the camera data 42 due to, for example, service performed on the vehicle 12 (e.g., service involving the camera 16, the LIDAR sensor 18, the windscreen, and/or other components of the vehicle 12). In the scope of the present disclosure, LiDAR to camera calibration parameters are extrinsic parameters (e.g., translation, rotation, and/or the like) which are applied to the LiDAR data 44 to align the LiDAR data 44 to the camera data 42.

In an exemplary embodiment, to determine the pre-alignment LIDAR to camera calibration parameters, the controller 14 uses an iterative LIDAR to camera alignment algorithm, as disclosed in, for example, U.S. Pat. No. 11,892,574, titled “DYNAMIC LIDAR TO CAMERA ALIGNMENT”, filed on Jul. 31, 2020, the entire contents of which is hereby incorporated by reference. The iterative LiDAR to camera alignment algorithm is used to determine a pre-alignment spatial transformation of the first plurality of LiDAR data points necessary to align the first plurality of LiDAR data points with the first plurality of camera data points based on the pre-alignment LiDAR data and pre-alignment camera data collected at block 104. The pre-alignment LiDAR to camera calibration parameters are determined based on the pre-alignment spatial transformation.

As discussed above, the pre-alignment LiDAR data and pre-alignment camera data include the first plurality of LiDAR data points and the first plurality of camera data points, and thus are relatively sparse. Use of the sparse pre-alignment data in the pre-alignment procedure allows for relatively quick and reliable convergence of the iterative LiDAR to camera alignment algorithm even with a large initial LiDAR to camera alignment error. After determining the pre-alignment LiDAR to camera calibration parameters at block 106, the controller 14 applies the pre-alignment LiDAR to camera calibration parameters to all future measurements performed using the LiDAR sensor 18 to decrease the initial LiDAR to camera alignment error. In a non-limiting example, the pre-alignment LiDAR to camera calibration parameters are stored in a calibration database in the media 28 of the controller 14. Blocks 104 and 106 of the method 100 are also referred to collectively as a pre-alignment procedure. After block 106, the method 100 proceeds to block 108.

At block 108, the controller 14 collects deep-alignment LiDAR data and deep-alignment camera data. In the scope of the present disclosure, the deep-alignment LiDAR data includes the second plurality of LiDAR data points. In the scope of the present disclosure, the deep-alignment camera data includes the second plurality of camera data points and the plurality of bounding boxes. The collection of the deep-alignment LiDAR data and deep-alignment camera data will be discussed in greater detail below. After block 108, the method 100 proceeds to block 110.

At block 110, the controller 14 determines final LiDAR to camera calibration parameters. In an exemplary embodiment, to determine the final LiDAR to camera calibration parameters, the controller 14 uses the iterative LiDAR to camera alignment algorithm as discussed above. The iterative LiDAR to camera alignment algorithm is used to determine a final spatial transformation of the second plurality of LiDAR data points necessary to align the second plurality of LiDAR data points with the second plurality of camera data points based on the deep-alignment LiDAR data and deep-alignment camera data collected at block 108. The final LiDAR to camera calibration parameters are determined based on the final spatial transformation.

As discussed above, the deep-alignment LiDAR data and deep-alignment camera data include the second plurality of LiDAR data points and the second plurality of camera data points, and thus are relatively dense when compared to the pre-alignment LiDAR data and the pre-alignment camera data. Use of the dense deep-alignment data in the deep-alignment procedure allows for refinement of the pre-alignment LiDAR to camera calibration parameters determined at block 106 using additional data to achieve accurate alignment between the LiDAR data 44 and the camera data 42. After determining the final LiDAR to camera calibration parameters at block 110, the controller 14 applies the final LiDAR to camera calibration parameters to all future measurements performed using the LiDAR sensor 18, overriding the pre-alignment LiDAR to camera calibration parameters and any existing and/or default LiDAR to camera calibration parameters. In a non-limiting example, the final LiDAR to camera calibration parameters are stored in a calibration database in the media 28 of the controller 14. Blocks 108 and 110 of the method 100 are also referred to collectively as a deep-alignment procedure. After block 110, the method 100 proceeds to enter a standby state at block 112.

In an exemplary embodiment, the controller 14 repeatedly exits the standby state 112 and restarts the method 100 at block 102. In a non-limiting example, the controller 14 exits the standby state 112 and restarts the method 100 on a timer, for example, every three hundred milliseconds.

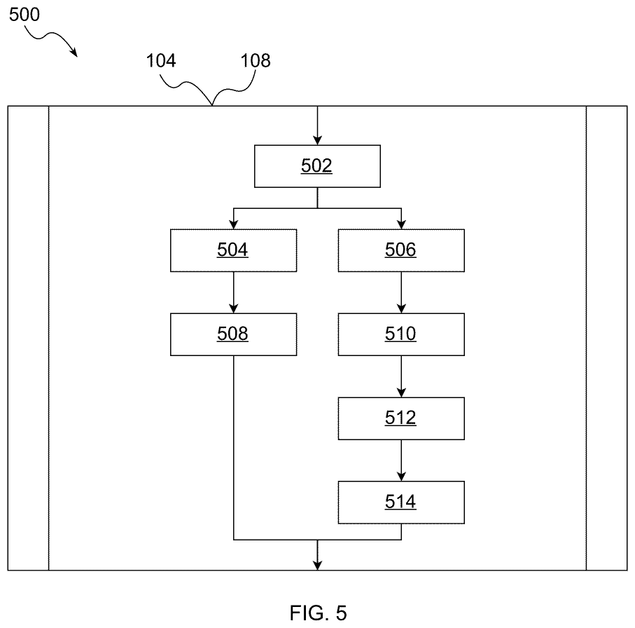

In FIG. 5, a flowchart of a method 500 for collecting LiDAR data and camera data is provided. Referring to FIG. 5 and with continued reference to FIGS. 1-4, in an exemplary embodiment, the method 500 is used to implement blocks 104 and 108 of the method 100. The method 500 begins at block 502. At block 502, the vehicle 12 is maneuvered through the parking lot aisle 34 of the parking lot 30. In an exemplary embodiment, the vehicle 12 is maneuvered using the predetermined driving path 36. In a non-limiting example, the predetermined driving path 36 is the S-shaped driving path having an approximately sinusoidal shape as shown in FIG. 2 and discussed above.

By maneuvering the vehicle 12 in the S-shaped driving path, the camera field-of-view 46 of the camera 16 and a LIDAR field-of-view of the LIDAR sensor 18 are filled with a high-density of alignment features (i.e., the plurality of parked vehicles 32), allowing for collection of a large quantity of camera data 42 and LiDAR data 44. In an exemplary embodiment, the vehicle 12 is maneuvered in the S-shaped driving path by an occupant. In another exemplary embodiment, the vehicle 12 is maneuvered in the S-shaped driving path by an automated driving system (not shown).

In an exemplary embodiment, the vehicle 12 is maneuvered in the S-shaped driving path at less than or equal to a predetermined maximum speed (e.g., five miles per hour). In a non-limiting example, the vehicle speed is determined using the IMU 20 and notifications are provided to the occupant of the vehicle 12 if the vehicle speed exceeds the predetermined maximum speed. In another exemplary embodiment, the vehicle 12 is maneuvered in the S-shaped driving path with less than or equal to a predetermined maximum yaw rate (e.g., 0.1 degrees per second). In a non-limiting example, the vehicle yaw rate is determined using the IMU 20 and notifications are provided to the occupant of the vehicle 12 if the vehicle yaw rate exceeds the predetermined maximum yaw rate.

It should be understood that, for at least the remainder of the execution of the method 500, the vehicle 12 continues to maneuver in the S-shaped driving path as described above. After block 502, the method 500 proceeds to blocks 504 and 506.

At block 504, the controller 14 uses the LiDAR sensor 18 to measure the plurality of LiDAR data points 44a while the vehicle 12 is maneuvering in the S-shaped driving path as described above. In an exemplary embodiment, when performing block 104 of the method 100, the LiDAR sensor 18 only measures the first plurality of LiDAR data points. In another exemplary embodiment, when performing block 108 of the method 100, the LiDAR sensor 18 measures the second plurality of LiDAR data points. In another exemplary embodiment, the LiDAR sensor 18 always measures the entirety of the plurality of LiDAR data points 44a, and the controller 14 processes the plurality of LiDAR data points 44a to generate the first plurality of LiDAR data points and the second plurality of LiDAR data points. When performing the deep-alignment procedure at block 108 of the method 100, the second plurality of LiDAR data points is used, providing a higher density of LiDAR data for the deep-alignment procedure. Each of the plurality of LiDAR data points 44a corresponds to a location of one of a plurality of edges of one of the plurality of parked vehicles 32. After block 504, the method 500 proceeds to block 508.

At block 508, the controller 14 performs a spatial transformation of the plurality of LiDAR data points 44a measured at block 504. In an exemplary embodiment, when performing block 104 of the method 100, the spatial transformation is performed using existing and/or default LiDAR to camera calibration parameters. In the scope of the present disclosure, existing LIDAR to camera calibration parameters include, for example, LiDAR to camera calibration parameters from a previous execution of the method 100. Default LIDAR to camera calibration parameters include, for example, predetermined LIDAR to camera calibration parameters determined during design, production, and/or initial calibration of the vehicle 12. In some examples, the existing and/or default LiDAR to camera calibration parameters may be zero, null, or uninitialized, in which case no spatial transformation is performed. In a non-limiting example, the existing and/or default LiDAR to camera calibration parameters are stored in a calibration database in the media 28 of the controller 14.

In another exemplary embodiment, when performing block 108 of the method 100, the pre-alignment LiDAR to camera calibration parameters determined at block 106 of the method 100 are used. In an exemplary embodiment, the controller 14 performs a spatial transformation (e.g., translation, rotation, and/or the like) of each of the plurality of LiDAR data points 44a measured at block 504 according to the pre-alignment LiDAR to camera calibration parameters determined at block 106 of the method 100. After block 508, the method 500 is concluded, and the method 100 proceeds as described above.

At block 506, the controller 14 uses the camera 16 to capture a plurality of images of the environment ahead of the vehicle 12 while the vehicle 12 is maneuvering in the S-shaped driving path and measuring the plurality of LiDAR data points 44a as described above. It should be understood that blocks 504 and 506 are performed simultaneously, such that the plurality of LiDAR data points 44a measured at block 504 and the plurality of images captured at block 506 are temporally aligned.

In an exemplary embodiment, when performing block 104 of the method 100 (i.e., during the pre-alignment procedure), the plurality of images is a first plurality of images including a first quantity of images. When performing block 108 of the method 100 (i.e., during the deep-alignment procedure), the plurality of images is a second plurality of images including a second quantity of images, where the second quantity of images is greater than the first quantity of images. After block 506, the method 500 proceeds to block 510.

At block 510, the controller 14 generates the plurality of bounding boxes (i.e., the bounding box 42b corresponding to each of the plurality of parked vehicles 32 detected in the parking lot 30 while the vehicle 12 is maneuvering in the S-shaped driving path as described above). Each of the plurality of bounding boxes identifies one of the plurality of parked vehicles 32 in the plurality of images captured at block 506. In an exemplary embodiment, the controller 14 uses a computer vision algorithm to identify the plurality of parked vehicles 32 and generate the plurality of bounding boxes.

In a non-limiting example, the computer vision algorithm utilizes machine learning techniques to analyze pixel-level information of an input image to detect and classify objects or patterns of interest. In a non-limiting example, the computer vision algorithm begins by preprocessing the input image through techniques such as, for example, image resizing, normalization, and/or filtering to reduce noise. Subsequently, the computer vision algorithm extracts relevant features from the input image using methods such as, for example, edge detection, corner detection, texture analysis, object classification, and/or the like. The computer vision algorithm may then utilize a machine learning model, such as, for example, a convolutional neural network (CNN), to classify and label relevant features of the input image based on learned patterns and associations.

In an exemplary embodiment, when performing block 104 of the method 100 (i.e., during the pre-alignment procedure), the plurality of bounding boxes is a first plurality of bounding boxes for the first plurality of images. When performing block 108 of the method 100 (i.e., during the deep-alignment procedure), the plurality of bounding boxes is a second plurality of bounding boxes for the second plurality of images. After block 510, the method 500 proceeds to block 512.

At block 512, the controller 14 detects the plurality of edges of each of the plurality of parked vehicles 32 in the plurality of images captured at block 506. In an exemplary embodiment, the controller 14 uses a computer vision algorithm, as discussed above, to identify and detect the plurality of edges of each of the plurality of parked vehicles 32 in the plurality of images captured at block 506.

In an exemplary embodiment, when performing block 104 of the method 100 (i.e., during the pre-alignment procedure), the plurality of edges includes a first plurality of edges determined based on the first plurality of images. When performing block 108 of the method 100 (i.e., during the deep-alignment procedure), the plurality of edges includes a second plurality of edges determined based on the second plurality of images. After block 512, the method 500 proceeds to block 514.

At block 514, the controller 14 determines the plurality of camera data points 42a. Each of the plurality of camera data points 42a corresponds to one of the plurality of edges identified at block 512 which is not one of the plurality of phantom camera data points 42a′. In other words, each of the plurality of camera data points 42a corresponds to one of the plurality of edges identified at block 512 which does not overlap with any of the plurality of bounding boxes generated at block 510. By identifying and ignoring phantom camera data points 42a′ (and thus phantom edges), the accuracy of the iterative LiDAR to camera alignment algorithm performed at blocks 106 and 110 of the method 100 is improved.

In an exemplary embodiment, when performing block 104 of the method 100 (i.e., during the pre-alignment procedure), the controller 14 determines the first plurality of camera data points based on the first plurality of edges. When performing block 108 of the method 100 (i.e., during the deep-alignment procedure), the controller 14 determines the second plurality of camera data points based on the second plurality of edges. When performing the deep-alignment procedure at block 108 of the method 100, the second plurality of camera data points is used, providing a higher density of camera data for the deep-alignment procedure. After block 514, the method 500 is concluded, and the method 100 proceeds as described above.

The system 10 and methods 100, 500 of the present disclosure offer several advantages. The S-shaped driving path used in the method 100 allows for robust data collection resulting in a large quantity of high-quality data including many alignment targets and variance in distance and angle of measurements. Furthermore, parking lots populated with parked vehicles are commonly available in the vicinity of vehicle service centers, increasing ease-of-use of the system 10 and method 100. Using the two-stage procedure including the pre-alignment procedure and the deep-alignment procedure, the method 100 is robust, even in cases of large initial LiDAR to camera alignment error. Additionally, filtering and removal of phantom data points and edges caused by boundaries of camera field-of-view increases data quality and decreases the occurrence of false or incomplete convergence of LIDAR to camera alignment algorithms.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method for determining light detection and ranging (LiDAR) to camera calibration parameters for a vehicle, the method comprising:
collecting pre-alignment LiDAR data including a first plurality of LiDAR data points and pre-alignment camera data including a first plurality of camera data points;
determining pre-alignment LiDAR to camera calibration parameters based on the pre-alignment LiDAR data and the pre-alignment camera data;
collecting deep-alignment LiDAR data including a second plurality of LiDAR data points and deep-alignment camera data including a second plurality of camera data points based at least in part on the pre-alignment LiDAR to camera calibration parameters, wherein the second plurality of LiDAR data points includes a greater quantity of LiDAR data points than the first plurality of LiDAR data points, and wherein the second plurality of camera data points includes a greater quantity of camera data points than the first plurality of camera data points; and
determining final LiDAR to camera calibration parameters based at least in part on the deep-alignment LiDAR data and the deep-alignment camera data.

2. The method of claim 1, wherein collecting the pre-alignment LiDAR data and the pre-alignment camera data further comprises:
maneuvering the vehicle through a parking lot using a predetermined driving path;
collecting the first plurality of LiDAR data points using a LIDAR sensor while the vehicle is following the predetermined driving path; and
collecting the first plurality of camera data points using a camera while the vehicle is following the predetermined driving path.

3. The method of claim 2, wherein maneuvering the vehicle through the parking lot using the predetermined driving path further comprises:
driving the vehicle through an aisle of the parking lot at less than or equal to a predetermined maximum speed, wherein the parking lot is populated with a plurality of parked vehicles; and
maneuvering the vehicle using the predetermined driving path, wherein the predetermined driving path is an S-shaped driving path.

4. The method of claim 2, wherein collecting the pre-alignment LiDAR data further comprises:
measuring the first plurality of LiDAR data points, wherein each of the first plurality of LiDAR data points corresponds to a location of one of a plurality of edges of one of a plurality of objects in an environment surrounding the vehicle, and wherein one or more of the first plurality of LiDAR data points has a location outside of a field-of-view of the camera.

5. The method of claim 4, wherein collecting the pre-alignment camera data further comprises:
capturing a first plurality of images using the camera, wherein the first plurality of images includes a first quantity of images;
generating a first plurality of bounding boxes on each of the first plurality of images, wherein each of the first plurality of bounding boxes identifies one of the plurality of objects in the first plurality of images;
detecting the plurality of edges of each of the plurality of objects in the plurality of images; and
determining the first plurality of camera data points, wherein each of the first plurality of camera data points corresponds to one of the plurality of edges which does not overlap with any of the first plurality of bounding boxes.

6. The method of claim 5, wherein determining pre-alignment LiDAR to camera calibration parameters further comprises:
determining a pre-alignment spatial transformation necessary to align the first plurality of LiDAR data points with the first plurality of camera data points; and
determining the pre-alignment LiDAR to camera calibration parameters based at least in part on the pre-alignment spatial transformation.

7. The method of claim 1, wherein collecting the deep-alignment LiDAR data and the deep-alignment camera data further comprises:
driving the vehicle through an aisle of a parking lot at less than or equal to a predetermined maximum speed, wherein the parking lot is populated with a plurality of parked vehicles;
maneuvering the vehicle using a predetermined driving path, wherein the predetermined driving path is an S-shaped driving path;
collecting the second plurality of LiDAR data points using a LIDAR sensor while the vehicle is following the S-shaped driving path;
performing a spatial transformation on the second plurality of LiDAR data points based at least in part on the pre-alignment LIDAR to camera calibration parameters; and
collecting the second plurality of camera data points using a camera while the vehicle is following the S-shaped driving path.

8. The method of claim 7, wherein collecting the deep-alignment LiDAR data further comprises:
measuring the second plurality of LiDAR data points, wherein each of the second plurality of LiDAR data points corresponds to a location of one of a plurality of edges of one of a plurality of objects in an environment surrounding the vehicle, and wherein one or more of the second plurality of LiDAR data points has a location outside of a field-of-view of the camera.

9. The method of claim 8, wherein collecting the deep-alignment camera data further comprises:
capturing a second plurality of images using the camera, wherein the second plurality of images includes a second quantity of images;
generating a second plurality of bounding boxes on each of the second plurality of images, wherein each of the second plurality of bounding boxes identifies one of the plurality of objects in the second plurality of images;
detecting the plurality of edges of each of the plurality of objects in the second plurality of images; and
determining the second plurality of camera data points, wherein each of the second plurality of camera data points corresponds to one of the plurality of edges which does not overlap with any of the second plurality of bounding boxes.

10. The method of claim 9, wherein determining the final LiDAR to camera calibration parameters further comprises:
determining a final spatial transformation necessary to align the second plurality of LiDAR data points with the second plurality of camera data points; and
determining the final LiDAR to camera calibration parameters based at least in part on the final spatial transformation.

11. A system for determining light detection and ranging (LiDAR) to camera calibration parameters for a vehicle, the system comprising:
a LIDAR sensor;
a camera;
a controller in electrical communication with the LiDAR sensor and the camera, wherein the controller is programmed to:
determine a pre-alignment LiDAR to camera calibration parameter using a pre-alignment procedure, wherein the pre-alignment procedure is performed using a sparse dataset;
apply the pre-alignment LiDAR to camera calibration parameter to decrease an initial LiDAR to camera alignment error; and
determine a final LiDAR to camera calibration parameter using a deep-alignment procedure, wherein the deep-alignment procedure is performed using a dense dataset.

12. The system of claim 11, wherein to determine the pre-alignment LiDAR to camera calibration parameter, the controller is further programmed to:
collect a first plurality of LiDAR data points using the LiDAR sensor while the vehicle is following an S-shaped driving path through an aisle of a parking lot populated with a plurality of parked vehicles; and
collect a first plurality of camera data points using the camera while the vehicle is following the S-shaped driving path through the aisle of the parking lot populated with the plurality of parked vehicles.

13. The system of claim 12, wherein to collect the first plurality of LiDAR data points and the first plurality of camera data points, the controller is further programmed to:
measure the first plurality of LiDAR data points, wherein each of the first plurality of LiDAR data points corresponds to a location of one of a plurality of edges of one of the plurality of parked vehicles in the parking lot, and wherein one or more of the first plurality of LiDAR data points has a location outside of a field-of-view of the camera;
capture a first plurality of images using the camera;
generate a first plurality of bounding boxes on each of the first plurality of images, wherein each of the first plurality of bounding boxes identifies one of the plurality of parked vehicles in the first plurality of images;
detect the plurality of edges of each of the plurality of parked vehicles in the first plurality of images; and
determine the first plurality of camera data points, wherein each of the first plurality of camera data points corresponds to one of the plurality of edges which does not overlap with any of the first plurality of bounding boxes.

14. The system of claim 13, wherein to determine the pre-alignment LiDAR to camera calibration parameter, the controller is further programmed to:
determine a pre-alignment spatial transformation necessary to align the first plurality of LiDAR data points with the first plurality of camera data points; and
determine the pre-alignment LiDAR to camera calibration parameter based at least in part on the pre-alignment spatial transformation.

15. The system of claim 14, wherein to determine the final LiDAR to camera calibration parameter, the controller is further programmed to:
collect a second plurality of LiDAR data points using the LiDAR sensor while the vehicle is following the S-shaped driving path through the aisle of the parking lot populated with the plurality of parked vehicles, wherein the second plurality of LiDAR data points includes a greater quantity of LiDAR data points than the first plurality of LiDAR data points; and
collect a second plurality of camera data points using the camera while the vehicle is following the S-shaped driving path through the aisle of the parking lot populated with the plurality of parked vehicles, wherein the second plurality of camera data points includes a greater quantity of camera data points than the first plurality of camera data points.

16. The system of claim 15, wherein to collect the second plurality of LiDAR data points and the second plurality of camera data points, the controller is further programmed to:
measure the second plurality of LiDAR data points, wherein each of the second plurality of LiDAR data points corresponds to a location of one of a plurality of edges of one of the plurality of parked vehicles in the parking lot, and wherein one or more of the second plurality of LiDAR data points has a location outside of a field-of-view of the camera;
capture a second plurality of images using the camera;
generate a second plurality of bounding boxes on each of the second plurality of images, wherein each of the second plurality of bounding boxes identifies one of the plurality of parked vehicles in the second plurality of images;
detect the plurality of edges of each of the plurality of parked vehicles in the second plurality of images; and
determine the second plurality of camera data points, wherein each of the second plurality of camera data points corresponds to one of the plurality of edges which does not overlap with any of the second plurality of bounding boxes.

17. The system of claim 16, wherein to determine the final LiDAR to camera calibration parameter, the controller is further programmed to:
determine a final spatial transformation necessary to align the second plurality of LiDAR data points with the second plurality of camera data points; and
determine the final LiDAR to camera calibration parameter based at least in part on the final spatial transformation.

18. A method for determining light detection and ranging (LiDAR) to camera calibration parameters for a vehicle, the method comprising:
maneuvering the vehicle through a parking lot using a predetermined driving path;
collecting a first plurality of LiDAR data points using a LIDAR sensor while the vehicle is following the predetermined driving path;
collecting a first plurality of camera data points using a camera while the vehicle is following the predetermined driving path;
determining pre-alignment LiDAR to camera calibration parameters based on the first plurality of LiDAR data points and the first plurality of camera data points;
collecting a second plurality of LiDAR data points using the LIDAR sensor while the vehicle is following the predetermined driving path, wherein the second plurality of LiDAR data points includes a greater quantity of LiDAR data points than the first plurality of LiDAR data points;
collecting a second plurality of camera data points using the camera while the vehicle is following the predetermined driving path, wherein the second plurality of camera data points includes a greater quantity of camera data points than the first plurality of camera data points;
performing a spatial transformation on the second plurality of LiDAR data points based at least in part on the pre-alignment LIDAR to camera calibration parameters; and
determining final LiDAR to camera calibration parameters based at least in part on the second plurality of LiDAR data points and the second plurality of camera data points.

19. The method of claim 18, wherein collecting the first plurality of LiDAR data points, the second plurality of LiDAR data points, the first plurality of camera data points, and the second plurality of camera data points further comprises:
measuring the first and second plurality of LiDAR data points, wherein each of the first and second plurality of LiDAR data points corresponds to a location of one of a plurality of edges of one of a plurality of objects in an environment surrounding the vehicle, and wherein one or more of the first and second plurality of LiDAR data points has a location outside of a field-of-view of the camera;
capturing a first plurality of images and a second plurality of images using the camera, wherein the second plurality of images includes a greater quantity of images than the first plurality of images;
generating a first plurality of bounding boxes on each of the first plurality of images and a second plurality of bonding boxes on each of the second plurality of images, wherein each of the first and second plurality of bounding boxes identifies one of the plurality of objects in the first plurality of images and the second plurality of images;
detecting a first plurality of edges of each of the plurality of objects in the first plurality of images and a second plurality of edges of each of the plurality of objects in the second plurality of images;
determining the first plurality of camera data points, wherein each of the first plurality of camera data points corresponds to one of the first plurality of edges which does not overlap with any of the first plurality of bounding boxes; and
determining the second plurality of camera data points, wherein each of the second plurality of camera data points corresponds to one of the second plurality of edges which does not overlap with any of the second plurality of bounding boxes.

20. The method of claim 19, wherein determining the final LiDAR to camera calibration parameters further comprises:
determining a final spatial transformation necessary to align the second plurality of LiDAR data points with the second plurality of camera data points; and
determining the final LiDAR to camera calibration parameters based at least in part on the final spatial transformation.
